(19) United States
(12) Patent Application Publication
(10) Pub. No.: US 2005/0122394 A1
(43) Pub. Date: Jun. 9, 2005

(54) Image display apparatus

(75) Inventors: Takeshi Furugoori, Tsurugashim-shi (JP); Masaru Ishikawa, Tokorozawa-shi (JP); Isao Tomisawa, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; PIONEER PRECISION MACHINERY CORPORATION

(21) Appl. No.: 11/002,206

(22) Filed: Dec. 3, 2004

(30) Foreign Application Priority Data
Dec. 8, 2003 (JP) P2003-409542

(51) Int. Cl. H04N 13/00

(52) U.S. Cl. 348/51; 348/42

(57) ABSTRACT

An image-display apparatus is provided with: one or a plurality of target display images that are to be displayed in three dimensions; a plurality of image-transmission device that are located away from said target display image in a space between the position of said target display image and the position of the view point for viewing said three dimensions display, and that forms a three dimensions image of that target display image in the space on the opposite side from said target display image; and a movement device that moves at least each of said image-transmission device or said target displays images such that the distance between a said image-transmission device and said target display image changes relatively, and moves each said image-transmission device independently from each other.

### BACKGROUND OF THE INVENTION

1. Field of the Invention

This invention relates to an image-display apparatus, and more particularly to an image-display apparatus for displaying an object or image in three dimensions (3D is called after).

2. Related Art

In recent years, the use of stereoscopic image systems in indoor decorations, display equipment for product sales displays in a store, or the like for displaying 2-dimensional images in 3D in order to provide a visual sensation or appealing effect, has been increasing.

As a prior stereoscopic image system having simple construction and capable of being made compact, is a stereoscopic image system using a so-called microlens array, and as a typical example of this prior technology is the stereoscopic image system disclosed in reference patent document 1 below. (Reference Patent Document 1: Japanese Patent Laid Open Application Number 2003-156712)

Also, in the prior stereoscopic image system described above, the position of the target display image (for example, a moving image or moving object displayed by a liquid-crystal display) to be displayed stereoscopically and the position of the microlens array were in a relatively fixed relationship.

However, when the position of the target display image and the position of the microlens array are relatively fixed, the position of the 3D image to be displayed by way of the microlens array also becomes fixed, and there is no depth in the display itself even in the case of a 3D display of a corner, so as a result there was a problem in that interest of the persons viewing the display is reduced.

### SUMMARY OF THE INVENTION

Taking the above inconveniences into consideration, the object of this invention is to provide an image-display apparatus that is capable of more effectively providing a 3D display to the person viewing the display, and thus provide more interesting and fun 3D images.

The above object of the present invention can be achieved by an image-display apparatus of the present invention. The image-display apparatus is provided with: one or a plurality of target display images that are to be displayed in three dimensions; a plurality of image-transmission device that are located away from said target display image in a space between the position of said target display image and the position of the view point for viewing said three dimensions display, and that forms a three dimensions image of that target display image in the space on the opposite side from said target display image; and a movement device that moves at least each of said image-transmission device or said target displays images such that the distance between a said image-transmission device and said target display image changes relatively, and moves each said image-transmission device independently from each other.

According to the present invention, with the operation of the image-display apparatus, an image-display panel on which the 3D image of the moving image to be displayed is formed is moved relative to a display unit to change the distance between that image-transmission panel and display unit, so visually it appears that the 3D image of the moving image moves such that the distance as seen from the view point changes, so the interest of a viewer in the 3D image of that moving image increases.

The above object of the present invention can be achieved by an image-display apparatus of the present invention. The image-display apparatus is provided with: a target display image that is to be displayed in three dimensions; an image-transmission device that is located away from the target display images and that forms a three dimensions image of the target display image in the space on the opposite side from the target display image; and a movement device that moves or removes the image-transmission device into or from the space between the position of the target display image and position of the viewpoint for viewing the three dimensions display.

According to the present invention, with the operation of the image-display apparatuses, an image-transmission panel that forms the moving image of the target display can be inserted in or removed from the space between a position on a display unit and the position of a view point for viewing the 3D image, so as the image-transmission panel moves, it appears that the 3D image of the moving image changes places with the moving image itself, making the 3D image of the moving image more interesting for the viewer.

In one aspect of the present invention can be achieved by the image-display apparatus of the present invention. The image-display apparatus of the present invention is, wherein two of the image-transmission device are arranged next to each other; and the movement device rotates each of the image-transmission device around an axis of rotation having a preset angle with respect to a straight line that connect the target display image and the view point.

According to the present invention, in addition to the visual effects obtained by the movement of the 3D image as in the case of an image-display apparatus, the shape of the 3D image itself changes according to a drive state of the motors, and thus the visual effect is further improved.

In another aspect of the present invention can be achieved by the image-display apparatus of the present invention. The image-display apparatus of the present invention is, wherein the image-transmission device is provided with a microlens array having a plurality of convex lenses on both sides that are arranged next to each other in a matrix shape.

According to the present invention, an image-transmission panel is a microlens array that is provided with a plurality of convex lenses on both surfaces that are arranged next to each other in a matrix shape, so the image-transmission panel has simple and lightweight construction, and is capable of displaying an interesting 3D image of a moving image.

In further aspect of the present invention can be achieved by the image-display apparatus of the present invention. The image-display apparatus of the present invention is, wherein the target display image is a moving image that is displayed on a flat display device.

According to the present invention, a moving image is displayed on a flat display unit, so it is possible to even more easily make the moving image appear in 3D.

The above object of the present invention can be achieved by an image-display apparatus of the present invention. The image-display is provided with: a target display image that is to be displayed in three dimensions; an image-transmission device that is located away from the target display image in between the position of the target display image and the position of the view point for viewing the three dimensions display, and that forms a three dimensions image of the target display image in the space on the opposite side from the target display object; and a movement device that moves the target display image and image-transmission device together.

According to the present invention, there is a plurality of image-transmission panels, and each image-transmission panel moves independently, so it is possible to display different 3D images in any direction making the display even more interesting.

### BRIEF DESCRIPTION OF THE DRAWINGS

FIG. 1 is a simplified cross-sectional drawing of the image-display apparatus of an embodiment of the invention;

FIG. 2 is a partial cross-sectional drawing of the microlens array of an embodiment of the invention;

FIG. 3 is a perspective drawing of the image-display apparatus of a first embodiment of the invention;

FIG. 4 is a cross-sectional drawing that explains the movement mechanism of the image-transmission panel of a first embodiment of the invention;

FIG. 5 is a flowchart explaining how to view the 3D image on the image-display apparatus of a first embodiment of the invention;

FIG. 6A is a perspective drawing of a first example of the image-display apparatus of a first embodiment of the invention;

FIG. 6B is a perspective drawing of a second example of the image-display apparatus of a first embodiment of the invention;

FIG. 6C is a perspective drawing of a third example of the image-display apparatus of a first embodiment of the invention;

FIG. 7A is a perspective drawing of a first example of the image-display apparatus of a second embodiment of the invention;

FIG. 7B is a perspective drawing of a second example of the image-display apparatus of a second embodiment of the invention; and

FIG. 8 is a perspective drawing of the image-display apparatus of a third embodiment of the invention.

### DESCRIPTION OF THE PREFERRED EMBODIMENTS OF THE INVENTION

Next, the preferred embodiments of the invention will be explained based on the drawings. The embodiments described below are embodiments in which the invention is applied to a moving image display apparatus such as that located in the center portion of a pachinko machine.

### (I) Theory of the Invention

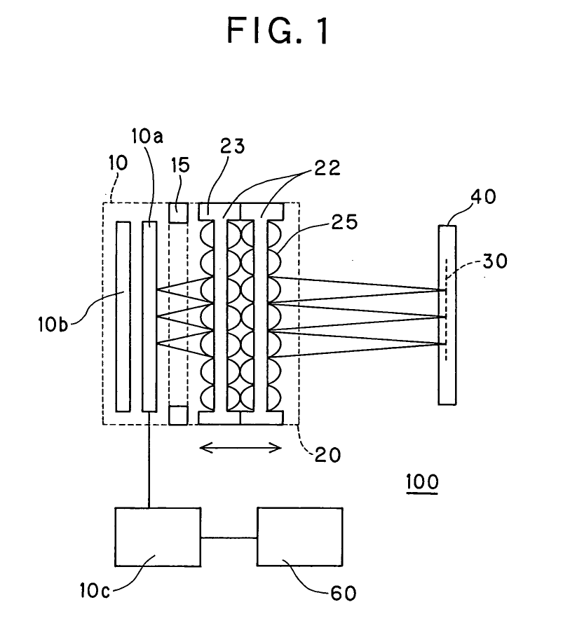

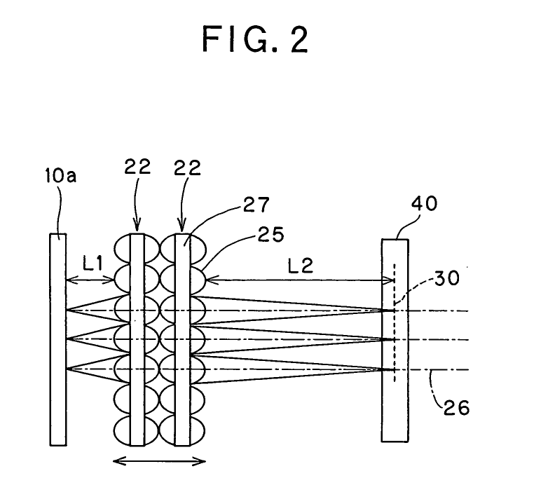

Before explaining the embodiments in detail, the theory of the invention will be explained using FIG. 1 and FIG. 2. FIG. 1 is a cross-sectional drawing of the image-display apparatus of the embodiments of this invention, and FIG. 2 is a partial cross-sectional drawing of the microlens array of the embodiments of the invention.

As shown in FIG. 1, the image-display apparatus 100 of the embodiments comprises: a display unit 10, an image-transmission panel 20 that is supported by a support member 15 and functions as an image-transmission means, a transparent panel 40 that is located near the imaging surface 30 image-transmission panel 20, and an video-signal-supply unit 60 that supplies a video signal to the display unit 10.

Here, the image-transmission panel 20 forms the image displayed on the display unit 10 in the space located on the opposite side from the display unit 10 (middle right side in FIG. 1) and forms the imaging surface 30 described above.

Also, the transparent panel 40 is plate shaped and made from a transparent material such as acrylic or glass, more specifically aquarium glass, window glass, front glass on a pachinko machine, or the like can be converted to be used as the transparent panel 40. Moreover, it is also possible to use a semi transparent color such as light blue as the transparent panel 40.

Next, the display unit 10 comprises a color liquid-crystal panel 10a having a flat image display screen on which images including moving images are displayed, a backlight-projection unit 10b and color liquid-crystal drive circuit 10c. Here, a cathode-ray tube, a plasma display, organic electro-luminescence display, or the like can be used as the display unit 10. Also, the color liquid-crystal drive circuit 10c is connected to the video-signal-supply unit 60 that supplies the video signal displayed on the liquid-crystal panel 10a.

Furthermore, the image-transmission panel 20 comprises a pair of microlens arrays 22, and each microlens array 22 comprises a lens frame area 23 that surrounds the effective range of that lens.

Here, a support member 15 supports the lens frame area 23, and the image-transmission panel 20 is separated from and located such that it is parallel with the image-display surface of the color liquid-crystal panel 10a.

Furthermore, the microlens array 22 is an erecting-prism and uniform-magnification optical system for viewing 2D images, including moving images, that are displayed on the image-display surface of the color liquid-crystal panel 10a, and has a lens effective surface area that covers the image-display surface.

Moreover, the lens frame area 23 is a dark color such as black, and is such that it keeps the viewer's awareness of the existence of the microlens array to a minimum.

Here, the microlens array 22 comprises a plurality of minute convex lenses 25 on both sides that are arranged next to each other in a matrix shape. Furthermore, as shown in FIG. 2, each microlens array 22 is attached and arranged such that the optical axes 26 of the convex lenses 25 are coaxial with each other. Here, the convex lens 25 formed on the right side surface of the microlens array 22 on the right side of FIG. 2 is such that the radius of curvature is larger than that of the convex lens 25 on the other surface, and the distance L2 (focal length) between the imaging surface 30 and the lens surface of the microlens array 22 on the right side in FIG. 2 is longer than the distance L1 (focal length) between the imaging surface (surface of the color liquid-crystal panel 10a) and the lens surface of the microlens array on the left side in FIG. 2.

By adequately separating the imaging surface 30 from the image-transmission panel 20, it is possible to make the image appear more 3-dimensional, and it is possible to make the depth of the image-display apparatus 100 more compact.

Also, in this invention, in the image-display apparatus 100 described above, the image-transmission panel 20 is constructed such that it can move in the directions shown by both arrows in FIG. 1 and FIG. 2 (or in other words, in the direction perpendicular to the display surface of the color liquid-crystal panel 10a). As a result of moving this image-transmission panel 20, the imaging surface 30 moves in the left-right direction in FIG. 1 and FIG. 2 together with the movement of the image-transmission panel 20. By doing this, the 3D image that is formed on the imaging screen 30 also appears to move in the left-right direction in FIG. 1 and FIG. 2, making viewing of that 3D image more interesting.

### (II) First Embodiment

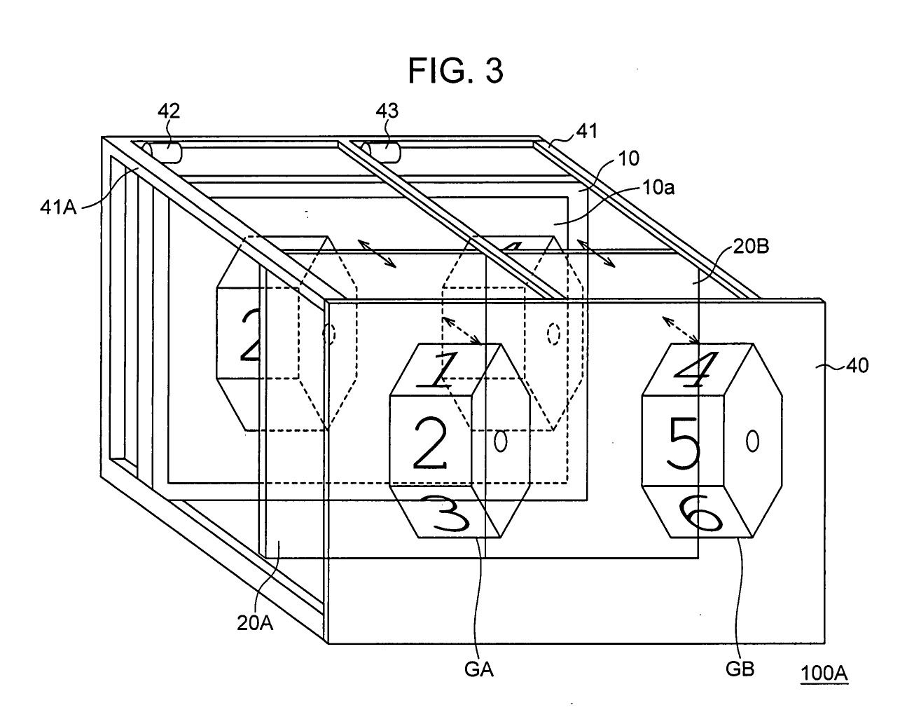

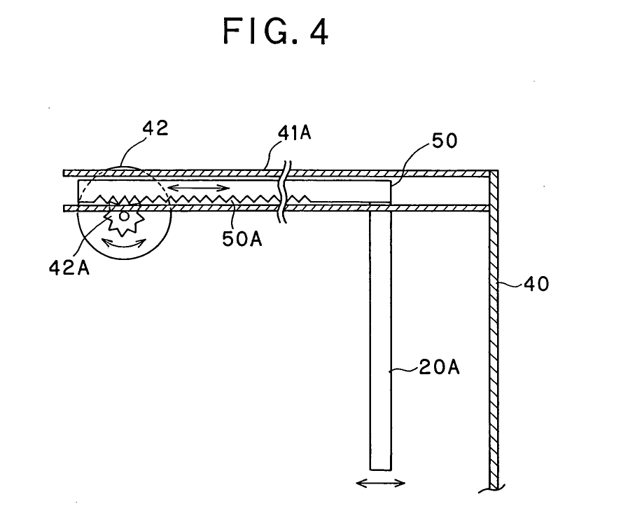

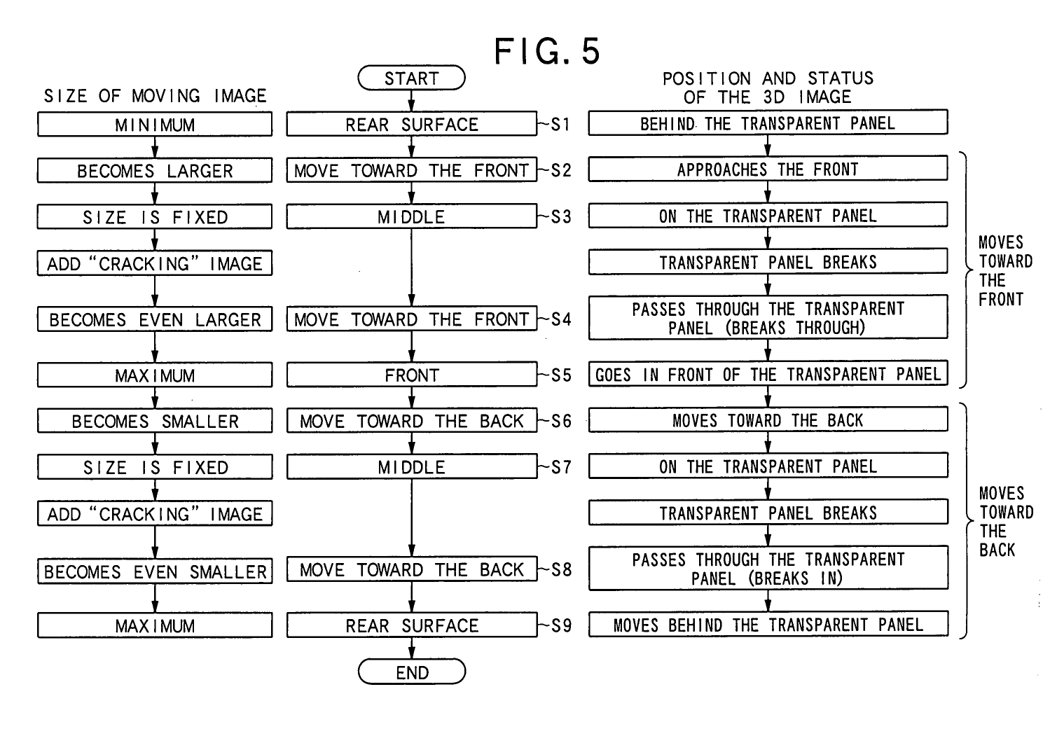

Next, FIG. 3 to FIG. 5 will be used to explain a first embodiment of the invention based on the theory described above. FIG. 3 is a perspective drawing of the image-display apparatus of a first embodiment of the invention, FIG. 4 is a cross-sectional drawing that explains the movement mechanism of the image-transmission panel 20, and FIG. 5 is a flowchart explaining how to view the 3D image on the image-display apparatus.

As shown in FIG. 3, the image-display apparatus 100A of this first embodiment comprises: a display unit 10 having the same construction as that shown in FIG. 1 and FIG. 2; image-transmission panels 20A and 20B having the same construction as the image-transmission panel 20 shown in FIG. 1 and FIG. 2, and where the surface area of each respectively makes up half of the color liquid-crystal panel 10a of the display unit 10; a transparent panel 40; a support frame 41 that supports the display unit 10 and transparent panel 40, and that is made of hollow angular metal rod; and motors 42 and 43 that are supported by the support frame 41 and function as a movement means for moving the image-transmission panels 20A and 20B independently from each other by way of the movement mechanism shown in FIG. 4 in the direction perpendicular to the color liquid-crystal panel 10a as shown by the arrows in FIG. 3.

Here, the image-transmission panels 20A and 20B are kept parallel with the color liquid-crystal panel 10a, and are independently moved in the direction shown by the arrows in FIG. 3. In this way, the images GA and GB (in FIG. 3, an example of images on a rotating roulette are shown) that are displayed in positions in the color liquid-crystal panel 10a corresponding to the image-transmission panels 20A and 20B are independent from each other, and are displayed such that the positions near the transparent panel 40 appear to move in the directions shown by the dashed lines.

Next, FIG. 4 will be used to explain in detail the movement mechanism of the image-transmission panels 20A and 20B. The construction of the movement mechanism of the image-transmission panel 20B is exactly the same as the construction of the movement mechanism of the image-transmission panel 20A, so FIG. 4 will be used to explain the movement mechanism of the image-transmission panel 20A.

As shown by the perspective drawing in FIG. 4, the image-transmission panel 20A is attached to an arm 50 that can move along the lengthwise direction of a member 41A that is part of the support frame 41. Here, the image-transmission panel 20A and the arm 50 are connected by a slit hole (not shown in the figure) that is located on the inner side of the member 41A.

Also, a rack 50A is formed on the arm 50, and with a gear 51 that is attached to a motor 42 engaged with the rack 50A, the motor 42 rotates that gear 51 and moves the image-transmission panel 20A in a straight line as shown in FIG. 3. At that time, a control unit (not shown in the figure) that includes a microcomputer (also not shown in the figure) electrically controls the rpm, direction of rotation and rotation time of the motor 42 (43) according to a control program that is prepared beforehand.

Next, the example shown in FIG. 5 will be used to explain the relationship between the image displayed on the display unit 10, the detailed movement of the image-transmission panel 20A or 20B (hereafter, referred to as the suitable image-transmission panel 20A), and the state of the 3D images that is changed by that movement.

As the display of the position of the image-transmission panel 20A in FIG. 5, the position of the image-transmission panel 20A when the imaging surface 30 shown in FIG. 1 is located at the position of the transparent panel 40 is taken to be the reference position, positions on the display unit 10 side from that position of the image-transmission panel 20A are taken to be rear surface positions, and positions on the transparent panel 40 side from that position of the image-transmission panel 20A are taken to be the front surface positions. Also, as the display of the position of the 3D image in FIG. 5, by positioning the imaging surface 30 shown in FIG. 1 on the display unit 10 side from the position of the transparent panel 40, the position when the 3D image appears to be positioned further on the display unit 10 side than the transparent panel 40 is taken to be positioned on the behind side, and by positioning the imaging surface 30 shown in FIG. 1 on the side from the transparent panel 40 that is opposite from the display unit 10, the position when the 3D image appears be on the side from the transparent panel 40 that is opposite from the display unit 10 (appears to be jumping out) is taken to be positioned on the front side.

As shown in FIG. 5, when first a small moving image is displayed on the display unit 10, and the position of the image-transmission panel 20A is taken to be the rear surface (step S1), the 3D image is positioned on the side behind the transparent panel 40, however, when the image-transmission panel 20 is moved from this state to the side of the transparent panel 40 and the moving image becomes larger (step S2), the 3D image is displayed such that it appears to approach the front side.

Next, when the image-transmission panel 20A is moved to the reference position by this movement (step S3), the 3D image appears to be located at exactly the position of the transparent panel 40. Also, in this state, when an image is added to the moving image in the display unit that looks like broken glass, the 3D image looks as though the transparent panel 40 is broken.

Next, when the image-transmission panel 20A is moved to the front surface position while the size of the moving image on the display unit 10 becomes even larger (step S4), the 3D image is displayed such that it appears to go past the transparent panel 40.

Also, when the image-transmission panel 20A is moved to the furthest position on the side of the transparent panel 40 and the moving image is the maximum size (step S5), the 3D image appears to be positioned further on the front side than the transparent panel 40.

Next, when the image-transmission panel 20A is moved toward the rear surface position and the size of the moving image becomes smaller (step S6), the 3D image appears to move in the direction behind the front side of the transparent panel 40.

Next, when the image-transmission panel 20A is returned by that movement to the reference position (step S7), the 3D image appears to return to the exact position of the transparent panel 40. Also, in this state, when an image is added again to the moving image in the display unit 10 that appears to be broken glass, the 3D images appears to break through to the inside of the transparent panel 40.

Next, when the image-transmission panel 20A is moved to the rear surface position and the moving image on the display unit 10 becomes even smaller (step S8), the 3D image is displayed such the it goes further toward the back past the transparent panel 40.

Also, when the image-transmission panel 20A is located at the furthest location on the display unit 10 side and the size of the moving image is a minimum (step S9), the 3D image appears to be located at the furthest position behind the transparent panel 40.

As was explained above, with the operation of the image-display apparatus 100A of this first embodiment, the image-display panel 20 on which the 3D image of the moving image to be displayed is formed is moved relative to the display unit 10 to change the distance between that image-transmission panel 20A and display unit 10, so visually it appears that the 3D image of the moving image moves such that the distance as seen from the view point changes, so the interest of the viewer in the 3D image of that moving image increases.

Also, there is a plurality of image-transmission panels 20A, and each image-transmission panel 20A or 20B moves independently, so it is possible to display different 3D images in any direction making the display even more interesting.

Furthermore, image-transmission panel 20A is a microlens array 22 that comprises a plurality of convex lenses on both surfaces that are arranged next to each other in a matrix shape, so the image-transmission panel 20A has simple and lightweight construction, and is capable of displaying an interesting 3D image of a moving image.

Moreover, the moving image is displayed on a flat display unit 10, so it is possible to even more easily make the moving image appear in 3D.

### (III) Second Embodiment

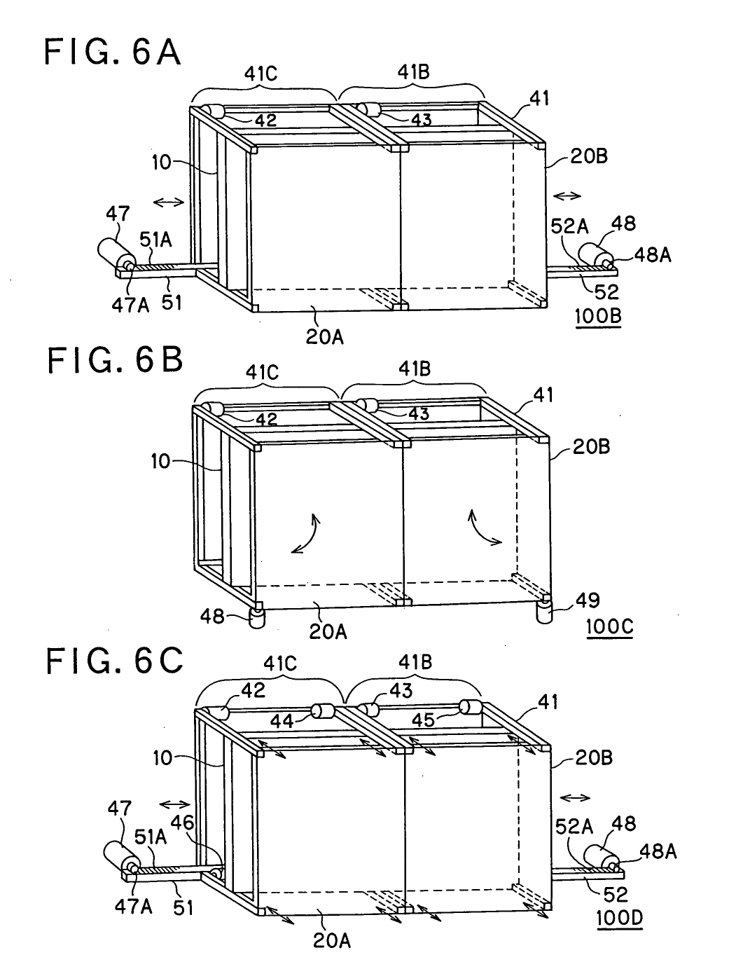

Next, FIG. 6A to FIG. 6C will be used to explain a second embodiment of this invention. FIG. 6A to FIG. 6C are perspective drawings of image-display apparatuses of a second embodiment of the invention, and in FIGS. 6A to 6C, in order to make the explanation more clear, the drawing of the transparent panel 40 is omitted, and for members that are the same as those of the image-display apparatus 100A of the first embodiment shown in FIG. 3, the same reference numbers are used and detailed explanations are omitted.

In the first embodiment described above, the case of moving the image-transmission panel 20A in both directions perpendicular to the display unit 10 was explained, however, in the second embodiment described below, the image-transmission panel 20A is moved in other directions beside this.

In other words, as a first example of the image-display apparatus 100B, the support frame 41 shown in FIG. 5 is divided into a support frame 41C that includes just the image-transmission panel 20A and a support-frame 41B that includes just the image-transmission panel 20B, and the support frame 41C is fastened to a support bar 51 on which a rack 51A is formed, and the support frame 41B is fastened to a support bar 52 on which a rack 52A is formed.

Also, by rotating a gear 47A that is engaged with the rack 51A by a motor 47, the entire support frame 41C moves in the left-right direction in FIG. 6, and moves the image-transmission panel 20A between a position on the front surface of the left half of the display unit 10 and a position other than the front surface of the display unit 10. On the other hand, by rotating a gear 48A that is engaged with the rack 52A by a motor 48, the entire support frame 41B moves in the left-right direction in FIG. 6, and moves the image-transmission panel 20B between a position on the front surface of the right half of the display unit 10 and a position other than the front surface of the display unit 10. Here, the rotation by the motors 47 and 48 is controlled such that the support frames 41B and 41C are moved independent of each other.

By doing this, in addition to the visual effects obtained by the movement of the 3D image as in the image-display apparatus 100A of the first embodiment, it is possible to select to view the moving image directly on the display unit 10 in addition to viewing the moving image in 3D, so the visual effect is further improved.

Also, as a second example of the image-display apparatus 100C, the support frame shown in FIG. 5 is divided into a support frame 41C and a support frame 41B as in the image-display apparatus 100B described above, and furthermore, together with rotating the image-transmission panel 20A in a plane perpendicular to it by a motor 48, the image-transmission panel 20B is rotated in a plane perpendicular to it by a motor 49.

By driving the motor 48 in this way, the image-transmission panel 20A is rotated back and forth between a position on the left half of the front surface of the display unit 10 and a position other than on the display unit 10. Also, by driving the motor 49 in the same way, the image-transmission panel 20B is rotated back and forth between a position on the right half of the front surface of the display unit 10 and a position other than on the display unit 10.

In this way, in addition to the visual effect obtained by moving the 3D image as in the case of the image-display apparatus 100A of the first embodiment, it is possible to select to directly view the moving image on the display unit 10, so the visual effect is further improved.

In this second example, the case shown in FIG. 6B of rotating the image-transmission panel 20A or 20B in a plane that is perpendicular to the image-transmission panel 20A or 20B was explained, however, instead of this, it is also possible to rotate the image-transmission panel 20A or 20B around a horizontal axis in FIG. 6B, or it is also possible to rotate around an axis having all angles with respect to the display unit 10.

Furthermore, as a third example of the image-display apparatus 100D, in addition to the construction of the image-display apparatus 100A described above, movement mechanisms (see FIG. 2) similar to those of the image-display apparatus of the first embodiment are located on the edges of the support frame 41 corresponding to each corner of the image-transmission panels 20A and 20B, and these movement mechanisms are driven by eight motors 42, 43, 44, 45, 46 located at each respective position corresponding to the corners.

Here, by driving each of the motors 42, 43, 44, 45, 46 independent from each other, it is possible to move the image-transmission panels 20A and 20B not only in a plane parallel with the display surface of the color liquid-crystal panel 10a, but also in various other planes.

In this way, in addition to the visual effects obtained by the movement of the 3D image as in the case of the image-display apparatus 100A of the first embodiment, the shape of the 3D image itself changes according to the drive state of the motors 42, 43, 44, 45, 46, and thus the visual effect is further improved.

As explained above, with the operation of the image-display apparatuses 100B to 100D of this second embodiment, in addition to the effects of the image-display apparatus 100A of the first embodiment, the image-transmission panel 20A that forms the moving image of the target display can be inserted in or removed from the space between a position on the display unit 10 and the position of a view point for viewing the 3D image, so as the image-transmission panel 20A moves, it appears that the 3D image of the moving image changes places with the moving image itself, making the 3D image of the moving image more interesting for the viewer.

With the operation of the image-display apparatus 100C of the second embodiment, two image-transmission panels 20A are arranged together, and each image-transmission means is rotated around an axis of rotation that is perpendicular with the straight line that connects the display unit 10 and the view point, so with this simple construction, as the image-transmission panel 20A moves, it is possible to make it appear that the 3D image of the moving image changes places with the moving image itself.

### (IV) Changed Embodiment

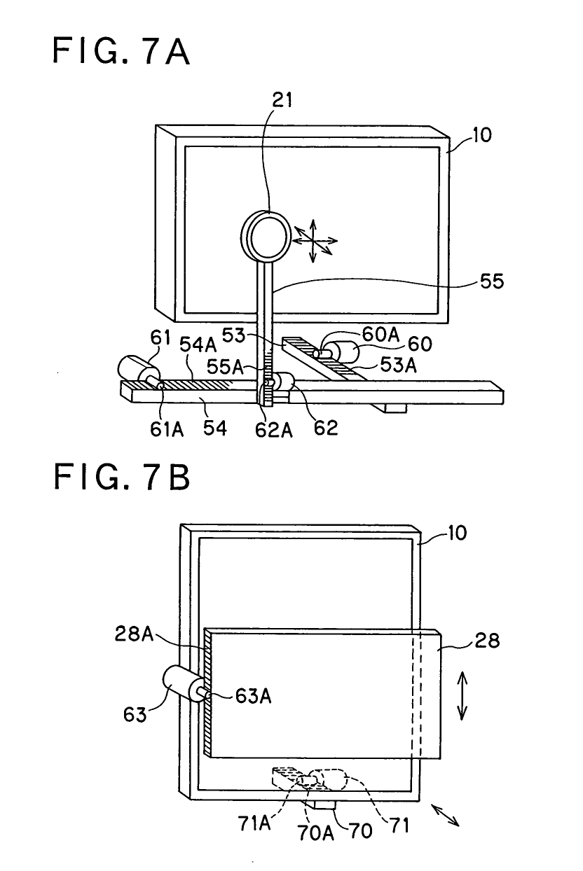

Next, FIG. 7A and FIG. 7B will be used to explain changes to the embodiments of the invention. FIG. 7A and FIG. 7B are perspective drawings of the changed image-display apparatuses. In FIG. 7A and FIG. 7B, in order to make the explanation more clear, the drawing of the transparent panel 40 is omitted, and the same reference number are given to component parts that are the same as those of the image-display apparatus 100A of the first embodiment shown in FIG. 3 and a detailed explanation of those parts is omitted.

In addition to the first and second embodiments described above, the present invention can be changed in various ways.

That is, as shown in FIG. 7A, in a first change to the invention, an image-transmission panel 21 shaped like a magnifying glass is placed in front of the display unit 10, and using a combination of a motor 62 that rotates a gear 62A that is engaged with a rack 55A formed on the support member 55 that supports the image-transmission panel 21, a motor 61 that rotates a gear 61A that is engaged with a rack 54A formed on the support member 54 that supports the support member 55, and a motor 60 that rotates a gear 60A that is engaged with a rack 53A formed on the support member 53 that supports the support member 54, it is possible to move the image-transmission panel 21 in all direction in front of the display unit 10.

Also, as shown in FIG. 7B, in a second change to the invention, a plate-shaped image-transmission panel 28 is placed in front of the display unit 19, and by attaching a motor 63 to the display unit 10 that rotates a gear 63A that is engaged with a rack 28A that is formed on one side of the image-transmission panel 28, and also having a motor 71 that rotates a gear 71A that is engaged with a rack 70A that is formed on the support member 70 that supports the display unit 10 to which the motor 63 is attached, not only is it possible to show only the part in the up-down direction of the moving image displayed on the display unit 10 in 3D, but it is also possible to change the position of that 3D image.

In the each of the embodiments and changes to the invention described above, the case of showing a moving image displayed on the display unit 10 as 3D image was explained, however, the invention is not limited to this, and can also be constructed such that by placing a simple moving object at the position of the display unit 10 and moving the image-transmission panel 20, it is possible to change the position of that 3D image.

### (V) Third Embodiment

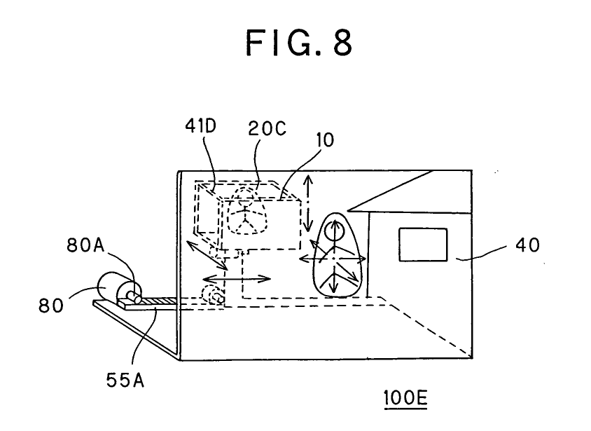

Next, FIG. 8 will be used to explain a third embodiment of the invention. FIG. 8 is a perspective drawing of the image-display apparatus of a third embodiment of the invention.

As shown in FIG. 8, the image-display apparatus 100E of this third embodiment of the invention comprises: a display unit 10 that has the same construction as shown in FIG. 1 and FIG. 2, an image-transmission panel 20C having the same construction as the image-transmission panel 20 shown in FIG. 1 and FIG. 2, and a transparent panel 40.

Here, the display unit 10 and image-transmission panel 20C are supported by a support frame 41D that is made of hollow angular metal rod or the like. As in the movement mechanism of the second embodiment, this support frame 41D is moved in the horizontal direction by a motor 80, gear 80A and rack 55A.

In this way, the display unit 10 supported by the support frame 41D and the image-transmission panel 20C move together as one member in the horizontal direction (left-right direction). Similarly, a movement mechanism is located in the vertical direction as well, and the display unit 10 and image-transmission panel 20C move together as one in the vertical direction (up-down direction). Moreover, it is also possible to have a plurality of display units 10 and image-transmission panels 20C, and to respectively support them with a plurality of support frames 41D, and move each support frame 41D independently or linked together.

In each of the embodiments or changes to the invention described above, in the image-display apparatus having one image-transmission panel, with that image-transmission panel installed in a fixed position, it is possible to move one or a plurality of display images relative to that image-transmission panel.

Furthermore, in an image-display apparatus having a plurality of image-transmission panels and plurality of display images, it is also possible to move either the image-transmission panels or display images or both such that the distance between the image-transmission panels and display images is relatively changed, and such that they are moved independent of each other.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-409542 filed on Dec. 8, 2003 including the specification, claims, drawings and summary are incorporated herein by reference in its entirety.

1. An image-display apparatus comprising:
one or a plurality of target display images that are to be displayed in three dimensions;
a plurality of image-transmission device that are located away from said target display image in a space between the position of said target display image and the position of the view point for viewing said three dimensions display, and that forms a three dimensions image of that target display image in the space on the opposite side from said target display image; and
a movement device that moves at least each of said image-transmission device or said target displays images such that the distance between a said image-transmission device and said target display image changes relatively, and moves each said image-transmission device independently from each other.

2. An image-display apparatus comprising:
a target display image that is to be displayed in three dimensions;
an image-transmission device that is located away from said target display images and that forms a three dimensions image of said target display image in the space on the opposite side from said target display image; and
a movement device that moves or removes said image-transmission device into or from the space between the position of said target display image and position of the viewpoint for viewing said three dimensions display.

3. The image-display apparatus according to claim 2 wherein
two of said image-transmission device are arranged next to each other; and
said movement device rotates each of said image-transmission device around an axis of rotation having a preset angle with respect to a straight line that connect said target display image and said view point.

4. The image-display apparatus according to claim 1 wherein
said image-transmission device comprises a microlens array having a plurality of convex lenses on both sides that are arranged next to each other in a matrix shape.

5. The image-display apparatus according to claim 4 wherein
said microlens array forms an upright image that corresponds to said target display image as said three dimensions image.

6. The image-display apparatus according to claim 1 wherein
said target display image is a moving image that is displayed on a flat display device.

7. The image-display apparatus according to claim 1 wherein
said target display image is a moving object.

8. An image-display apparatus comprising:
a target display image that is to be displayed in three dimensions;
an image-transmission device that is located away from said target display image in between the position of said target display image and the position of the view point for viewing said three dimensions display, and that forms a three dimensions image of said target display image in the space on the opposite side from said target display object; and
a movement device that moves said target display image and image-transmission device together.
